(19) United States
(12) Patent Application Publication
(10) Pub. No.: US 2026/0279665 A1
(43) Pub. Date: Sep. 17, 2026

(54) MULTILAYER CERAMIC CAPACITOR

(71) Applicant: Murata Manufacturing Co., Ltd., Nagaokakyo-shi (JP)

(72) Inventors: Ryotaro HANABUSA, Nagaokakyo-shi (JP); Takashi SAWADA, Nagaokakyo-shi (JP); Kazuhiro NISHIBAYASHI, Nagaokakyo-shi (JP)

(21) Appl. No.: 19/663,977

(22) Filed: Apr. 30, 2026

Related U.S. Application Data
(63) Continuation of application No. PCT/JP2025/009216, filed on Mar. 12, 2025.

(51) Int. Cl. H01G 4/008; H01G 4/12; H01G 4/232; H01G 4/248; H01G 4/30

(52) U.S. Cl. CPC H01G 4/008; H01G 4/12; H01G 4/2325; H01G 4/248; H01G 4/30

(57) ABSTRACT

A multilayer ceramic capacitor includes a multilayer body including dielectric layers and first and second inner electrode layers, and first to fourth outer electrodes on the multilayer body. Each of the first inner electrode layers includes a first opposing electrode portion facing a respective one of the second inner electrode layers with a respective one of the dielectric layers interposed therebetween, a first extended portion extending from the first opposing electrode portion, and a second extended portion extending from the first opposing electrode portion. Each of the dielectric layers including a respective one of the first inner electrode layers thereon includes a first side portion including the first extended portion, and a second side portion including the second extended portion. The first and second side portions have different Ni contents on opposite sides of the first and second extended portions.

### CROSS REFERENCE TO RELATED APPLICATIONS

This application is a Continuation Application of PCT Application No. PCT/JP2025/009216 filed on Mar. 12, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

For example, a decoupling capacitor that is used for stabilizing a power supply voltage to be supplied to an integrated circuit (IC) component configured to operate at high speed and a feed-through multilayer ceramic capacitor that is used for noise countermeasures for a power supply line to be supplied to an integrated circuit (IC) component are known. For example, a feed-through multilayer ceramic capacitor generally includes a ceramic base body (multilayer body) having an outer surface including first and second main surfaces facing each other, first and second side surfaces facing each other, and first and second end surfaces facing each other. Inside the ceramic base body, a plurality of first inner electrodes and a plurality of second inner electrodes are alternately arranged in a stacking direction. The two ends of each of the first inner electrodes are extended to a first side surface and a second side surface and are respectively connected to a third outer electrode and a fourth outer electrode. In addition, the two ends of each of the second inner electrodes are extended to a first end surface and a second end surface and are respectively connected to a first outer electrode and a second outer electrode.

In a step of firing multilayer chips, firing is generally performed by mounting chips on a sagger and passing the sagger through a tunnel firing furnace.

### SUMMARY OF THE INVENTION

However, when the orientations of chips on a sagger are random, temperature variations occur in the chips when they enter a firing furnace, and there is a risk that cracks may occur inside the chips due to a dimensional shrinkage difference resulting from the temperature variations.

Accordingly, example embodiments of the present invention provide multilayer ceramic capacitors each capable of reducing or preventing cracks in the multilayer ceramic capacitor during firing in a firing furnace.

A multilayer ceramic capacitor according to an example embodiment of the present invention includes a multilayer body including a plurality of stacked dielectric layers and a plurality of inner electrode layers stacked on the dielectric layers, a first surface and a second surface facing each other in a stacking direction, a third surface and a fourth surface facing each other in a first direction orthogonal to the stacking direction, and a fifth surface and a sixth surface facing each other in a second direction orthogonal to the stacking direction and to the first direction, a first outer electrode on the third surface, a second outer electrode on the fourth surface, a third outer electrode on the fifth surface, and a fourth outer electrode on the sixth surface. The plurality of inner electrode layers include a plurality of first inner electrode layers and a plurality of second inner electrode layers. Each of the first inner electrode layers includes a first opposing electrode portion facing a respective one of the second inner electrode layers with a respective one of the dielectric layers interposed therebetween, a first extended portion extending from the first opposing electrode portion and extended to the fifth surface, and a second extended portion extending from the first opposing electrode portion and extended to the sixth surface. Each of the dielectric layers on which a respective one of the first inner electrode layers is provided includes a first side portion located between the fifth surface and the first opposing electrode portion and including the first extended portion, and a second side portion located between the sixth surface and the first opposing electrode portion and including the second extended portion. A size of the multilayer ceramic capacitor in the first direction is about 0.30 mm or greater and about 0.70 mm or less. A size of the multilayer ceramic capacitor in the second direction is about 0.10 mm or greater and about 0.40 mm or less. The first and second side portions include, on opposite sides of the first and second extended portions, respectively, a Ni content on one side and a Ni content on another side that are different from each other.

In a step of firing multilayer chips, the multilayer chips are generally mounted on a sagger, and firing is performed by passing the sagger through a tunnel firing furnace. However, when the orientations of the multilayer chips on the sagger are random, temperature variations occur in the multilayer chips when they enter the firing furnace, and there is a risk that cracks may occur inside the multilayer chips due to a dimensional shrinkage difference resulting from the temperature variations. In addition, as a component size becomes smaller, the proportion of a region where no inner electrode layers are printed relative to the total volume of the multilayer body increases, and thus, there is a possibility that an influence of a shrinkage difference between a region where inner electrode layers are printed and the region where no inner electrode layers are printed will become larger.

In a multilayer ceramic capacitor according to an example embodiment of the present invention, in the dielectric layers on which the first inner electrode layers are provided, the first side portion that is located between the fifth surface and the first opposing electrode portion and that includes the first extended portion, and the second side portion that is located between the sixth surface and the first opposing electrode portion and that includes the second extended portion are provided. The size of the multilayer ceramic capacitor in the first direction is about 0.30 mm or greater and about 0.70 mm or less. The size of the multilayer ceramic capacitor in the second direction is about 0.10 mm or greater and about 0.40 mm or less. The first and second side portions include, on opposite sides of the first and second extended portions, respectively, a Ni content on one side and a Ni content on another side that are different from each other. Since sintering tends to proceed more easily and a dimensional shrinkage rate tends to increase on a side having a higher Ni content, by causing a side having a lower Ni content to enter the firing furnace first, a dimensional shrinkage difference due to temperature variations is reduced, and structural defects are reduced or prevented.

According to example embodiments of the present invention, multilayer ceramic capacitors each capable of reducing or preventing cracks in the multilayer ceramic capacitor during firing in a firing furnace are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to an example embodiment of the present invention.

FIG. 2 is a top view illustrating an example of a multilayer ceramic capacitor according to an example embodiment of the present invention.

FIG. 3 is a bottom view illustrating an example of a multilayer ceramic capacitor according to an example embodiment of the present invention.

FIG. 4 is a side view illustrating an example of a multilayer ceramic capacitor according to an example embodiment of the present invention.

FIG. 5 is a sectional view taken along line V-V of FIG. 1.

FIG. 6 is a sectional view taken along line VI-VI of FIG. 1.

FIG. 7 is a sectional view taken along line VII-VII of FIG. 4.

FIG. 8 is a sectional view taken along line VIII-VIII of FIG. 4.

FIG. 9 is a modification of a dielectric layer in which a first inner electrode layer illustrated in FIG. 7 is provided.

FIG. 10 is a modification of a dielectric layer in which a second inner electrode layer illustrated in FIG. 8 is provided.

### DETAILED DESCRIPTION OF THE EXAMPLE EMBODIMENTS

A multilayer ceramic capacitor 10 according to a first example embodiment of the present invention will be described. The multilayer ceramic capacitor 10 is a feed-through multilayer ceramic capacitor (a three-terminal multilayer ceramic capacitor), for example.

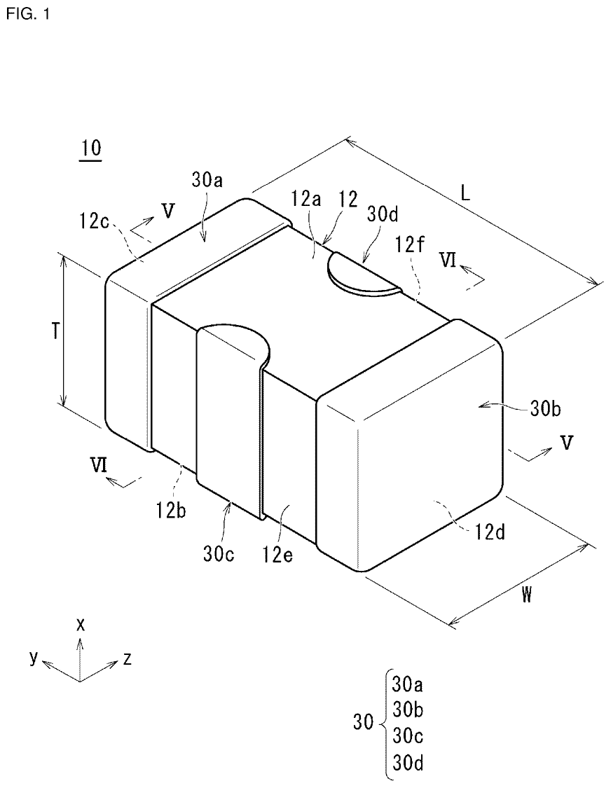

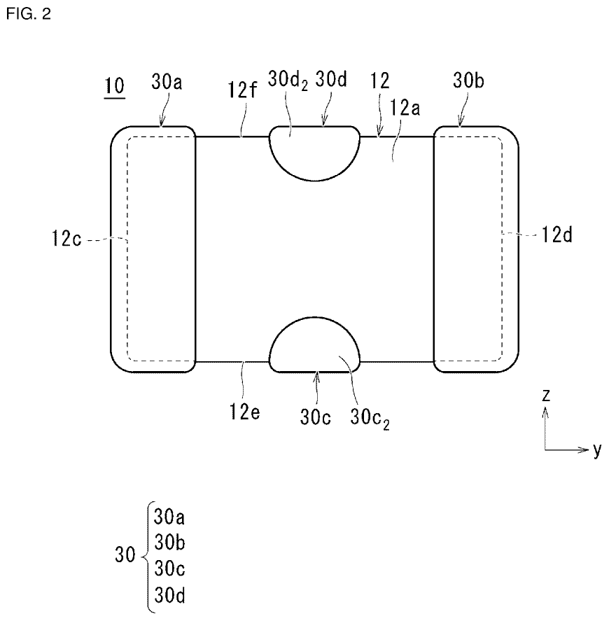

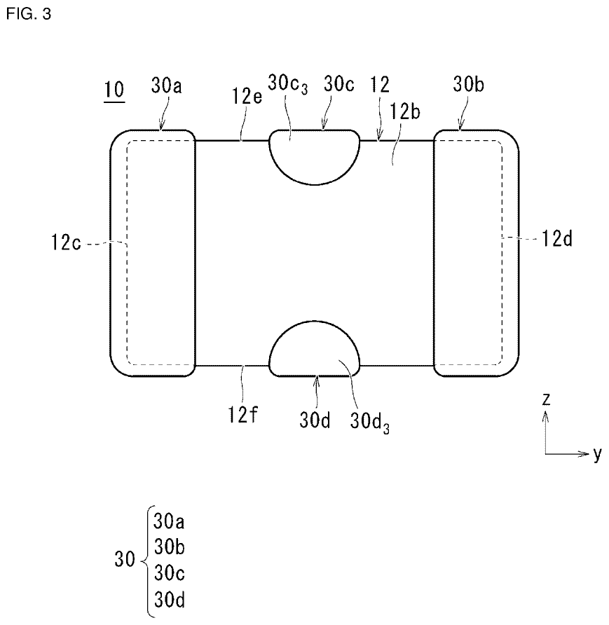

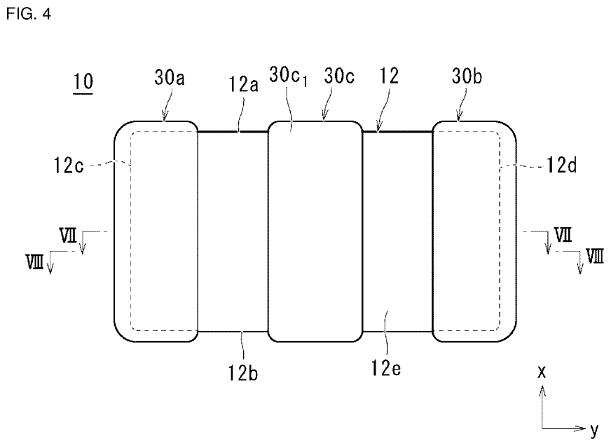

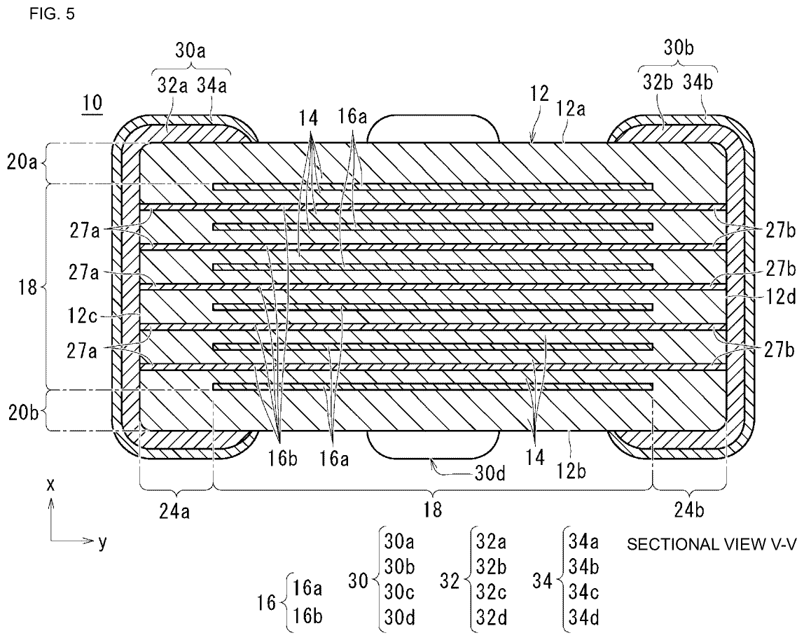

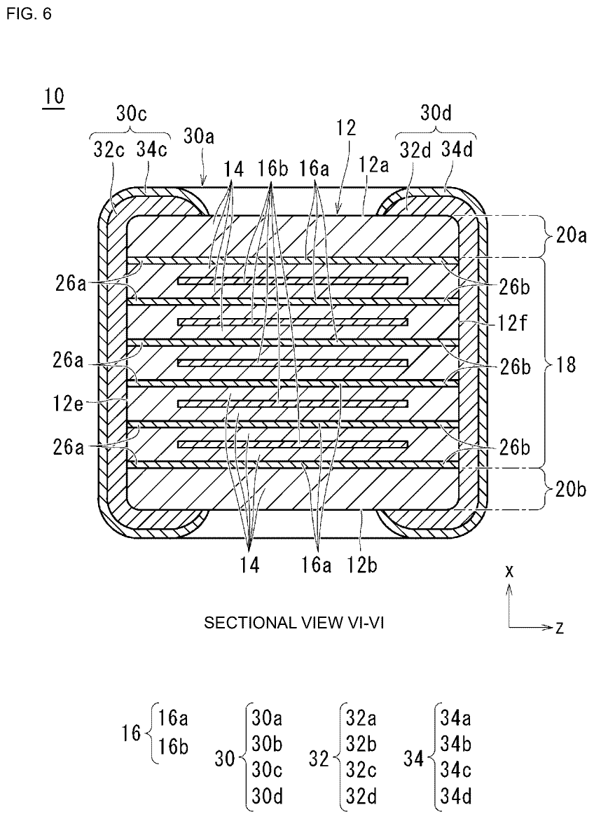

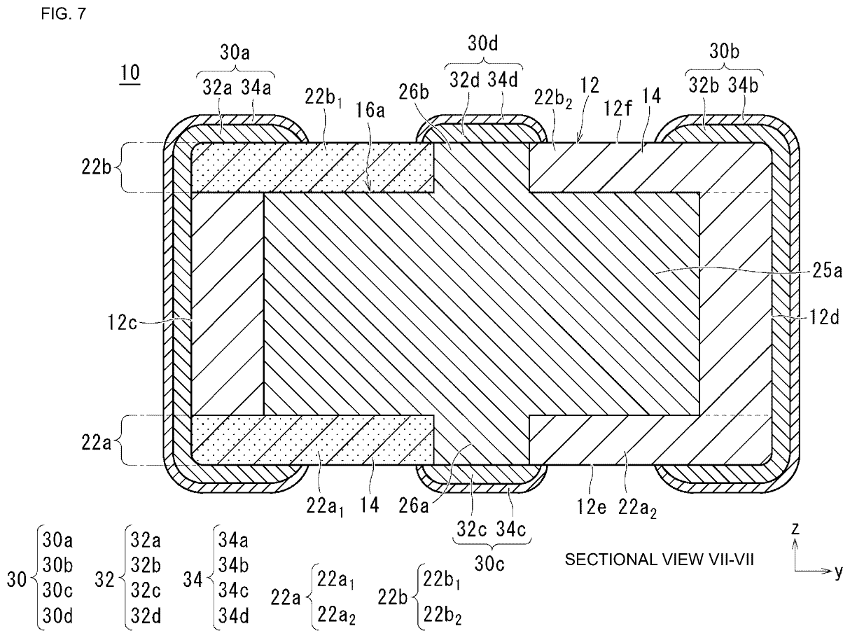

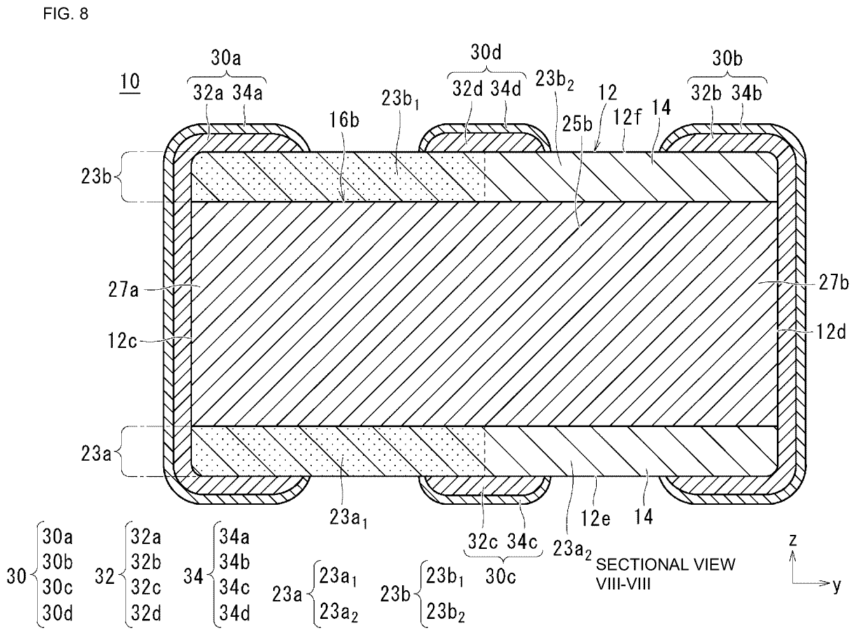

FIG. 1 is an external perspective view illustrating an example of a multilayer ceramic capacitor according to an example embodiment of the present invention. FIG. 2 is a top view illustrating an example of a multilayer ceramic capacitor according to an example embodiment of the present invention. FIG. 3 is a bottom view illustrating an example of a multilayer ceramic of the present capacitor according to an example embodiment invention. FIG. 4 is a side view illustrating an example of a multilayer ceramic capacitor according to an example embodiment of the present invention. FIG. 5 is a sectional view taken along line V-V of FIG. 1. FIG. 6 is a sectional view taken along line VI-VI of FIG. 1. FIG. 7 is a sectional view taken along line VII-VII of FIG. 4. FIG. 8 is a sectional view taken along line VIII-VIII of FIG. 4.

As illustrated in FIGS. 1 to 8, the multilayer ceramic capacitor 10 includes, for example, a multilayer body 12 and outer electrodes 30.

The multilayer body 12 includes a plurality of stacked dielectric layers 14 and a plurality of inner electrode layers 16 stacked on the dielectric layers 14. The inner electrode layers 16 include first inner electrode layers 16a and second inner electrode layers 16b. Details of the first inner electrode layers 16a and the second inner electrode layers 16b will be described below.

The multilayer body 12 includes a first surface 12a and a second surface 12b facing each other in a stacking direction x, a third surface 12c and a fourth surface 12d facing each other in a first direction y orthogonal to the stacking direction x, and a fifth surface 12e and a sixth surface 12f facing each other in a second direction z orthogonal to the stacking direction x and to the first direction y.

The multilayer body 12 has a rectangular parallelepiped shape, and it is preferable that corner portions and ridge portions of the multilayer body 12 be rounded. Each corner portion is a portion where three surfaces of the multilayer body 12 intersect with each other, and each ridge portion is a portion where two surfaces of the multilayer body 12 intersect with each other. In addition, irregularities or the like may be formed on a portion of or the entirety of each of the first surface 12a, the second surface 12b, the third surface 12c, the fourth surface 12d, the fifth surface 12e, and the sixth surface 12f.

The dimensions of the multilayer body 12 are not particularly limited.

The multilayer body 12 includes a capacitance generating portion 18 and a first outer layer portion 20a that is positioned on the first surface 12a side and a second outer layer portion 20b that is positioned on the second surface 12b side, the first outer layer portion 20a and the second outer layer portion 20b being arranged so as to sandwich the capacitance generating portion 18 in the stacking direction x.

In the capacitance generating portion 18, the first inner electrode layers 16a and the second inner electrode layers 16b are alternately stacked with the dielectric layers 14 interposed therebetween.

The first outer layer portion 20a is positioned on the first surface 12a side of the multilayer body 12, positioned between the first surface 12a and the capacitance generating portion 18 that is closest to the first surface 12a, and is an assembly of the plurality of dielectric layers 14. In addition, the second outer layer portion 20b is positioned on the second surface 12b side of the multilayer body 12, positioned between the second surface 12b and the capacitance generating portion 18 that is closest to the second surface 12b, and is an assembly of the plurality of dielectric layers 14. Furthermore, a region sandwiched between the first outer layer portion 20a and the second outer layer portion 20b is the capacitance generating portion 18.

Here, as illustrated in FIG. 5, the multilayer body 12 includes end portions (L-gaps) 24a and 24b of the multilayer body 12 that are positioned between the capacitance generating portion 18 and the third surface 12c and between the capacitance generating portion 18 and the fourth surface 12d and that include a first lead-out portion 27a and a second lead-out portion 27b of the second inner electrode layers 16b.

For the dielectric layers 14, for example, a dielectric ceramic including a component such as BaTio₃, CaTio₃, SrTiO₃, or CaZro₃ can be used as a ceramic material. In addition, a material in which a sub-component such as a Mn compound, an Fe compound, a Cr compound, a Co compound, or a Ni compound is added to these main components may be used.

A thickness of each of the dielectric layers 14 is preferably about 0.30 μm or greater and about 2.00 μm or less, for example. In addition, the number of the dielectric layers 14 that are stacked is preferably 90 or more and 650 or less, for example. Note that the number of the dielectric layers 14 is the total of the number of the dielectric layers 14 of the capacitance generating portion 18, the number of the dielectric layers 14 of the first outer layer portion 20a, and the number of the dielectric layers 14 of the second outer layer portion 20b.

The inner electrode layers 16 include the first inner electrode layers 16a and the second inner electrode layers 16b.

Each of the first inner electrode layers 16a is provided on a respective one of the plurality of dielectric layers 14. In addition, the first inner electrode layers 16a are extended to the fifth surface 12e and the sixth surface 12f.

More specifically, as illustrated in FIG. 7, each of the first inner electrode layers 16a extends between the fifth surface 12e and the sixth surface 12f of the multilayer body 12 and includes a first opposing electrode portion 25a that corresponds to a center portion thereof, a first extended portion 26a that extends from the first opposing electrode portion 25a and that is extended to the fifth surface 12e, and a second extended portion 26b that extends from the first opposing electrode portion 25a and that is extended to the sixth surface 12f. Each of the first opposing electrode portions 25a is formed in a rectangular shape so as to extend in the direction toward the third surface 12c and to extend in the direction toward the fourth surface 12d. Each of the first opposing electrode portions 25a is positioned at a center portion on the corresponding dielectric layer 14. The first extended portions 26a are exposed at the fifth surface 12e of the multilayer body 12, and the second extended portions 26b are exposed at the sixth surface 12f of the multilayer body 12. Thus, each of the first inner electrode layers 16a is not exposed at either the third surface 12c or the fourth surface 12d of the multilayer body 12.

Although the shapes of the first opposing electrode portion 25a, the first extended portion 26a, and the second extended portion 26b of each of the first inner electrode layers 16a are not particularly limited, they are preferably rectangular shapes in plan view. However, corner portions may be rounded.

Each of the second inner electrode layers 16b is provided on a respective one of the plurality of dielectric layers 14. In addition, the second inner electrode layers 16b are extended to the third surface 12c and the fourth surface 12d. The second inner electrode layers 16b are disposed on the dielectric layers 14 that are different from the dielectric layers 14 on which the first inner electrode layers 16a are disposed.

More specifically, as illustrated in FIG. 8, each of the second inner electrode layers 16b extends between the third surface 12c and the fourth surface 12d of the multilayer body 12 and includes a second opposing electrode portion 25b that corresponds to a center portion thereof, a first lead-out portion 27a that extends from the second opposing electrode portion 25b and that is extended to the third surface 12c of the multilayer body 12, and a second lead-out portion 27b that extends from the second opposing electrode portion 25b and that is extended to the fourth surface 12d of the multilayer body 12. Each of the second opposing electrode portions 25b is positioned at a center portion on the corresponding dielectric layer 14. The first lead-out portions 27a are exposed at the third surface 12c of the multilayer body 12, and the second lead-out portions 27b are exposed at the fourth surface 12d of the multilayer body 12. Thus, each of the second inner electrode layers 16b is not exposed at either the fifth surface 12e or the sixth surface 12f of the multilayer body 12.

Although the shape of each of the second inner electrode layers 16b is not particularly limited, it is preferably a rectangular shape in plan view. In addition, although the shapes of the second opposing electrode portion 25b, the first lead-out portion 27a, and the second lead-out portion 27b of each of the second inner electrode layers 16b are not particularly limited, they are preferably rectangular shapes in plan view. However, corner portions may be rounded.

Each of the first opposing electrode portions 25a of the first inner electrode layers 16a faces a respective one of the second opposing electrode portions 25b of the second inner electrode layers 16b. In the present example embodiment, each of the first opposing electrode portions 25a of the first inner electrode layers 16a and a respective one of the second opposing electrode portions 25b of the second inner electrode layers 16b face each other with a respective one of the dielectric layers 14 interposed therebetween, so that a capacitance is generated, thereby exhibiting characteristics of a capacitor.

Although the number of the first inner electrode layers 16a is not particularly limited, it is preferably, for example, 37 or more and 300 or less. In addition, although the number of the second inner electrode layers 16b is not particularly limited, it is preferably, for example, 37 or more and 300 or less. Accordingly, the total of the number of the first inner electrode layers 16a and the number of the second inner electrode layers 16b is preferably 74 or more and 600 or less, for example.

Although a thickness of each of the first inner electrode layers 16a is not particularly limited, it is preferably, for example, about 0.30 μm or greater and about 2.0 μm or less. In addition, although a thickness of each of the second inner electrode layers 16b is not particularly limited, it is preferably, for example, about 0.30 μm or greater and about 2.0 μm or less.

In addition, by providing Sn layers between the first and second inner electrode layers 16a and 16b and the dielectric layers 14, the likelihood of electric field concentration at the interfaces between the inner electrode layers 16 and the dielectric layers 14 can be reduced, which in turn leads to improvement of high-temperature load reliability.

The first inner electrode layers 16a and the second inner electrode layers 16b can be made of, for example, a suitable conductive material. Examples of the suitable conductive material include metals such as Ni, Cu, Ag, Pd, and Au, an Ag—Pd alloy, and an alloy including at least one of these metals.

Each of the dielectric layers 14 on which a respective one of the first inner electrode layers 16a is provided includes a first side portion 22a that is located between the fifth surface 12e and the first opposing electrode portion 25a and that includes the corresponding first extended portion 26a, and a second side portion 22b that is located between the sixth surface 12f and the first opposing electrode portion 25a and that includes the corresponding second extended portion 26b.

In each of the dielectric layers 14 on which a respective one of the first inner electrode layers 16a is provided, the first side portion 22a includes one first side portion 22a₁ that is located closer to the third surface 12c and another first side portion 22a₂ that is located closer to the fourth surface 12d, with the first extended portion 26a interposed between the one first side portion 22a₁ and the other first side portion 22a₂.

In each of the dielectric layers 14 on which a respective one of the first inner electrode layers 16a is provided, the second side portion 22b includes one second side portion 22b₁ that is located closer to the third surface 12c and another second side portion 22b₂ that is located closer to the fourth surface 12d, with the second extended portion 26b interposed between the one second side portion 22b₁ and the other second side portion 22b₂.

The Ni content in the one first side portion 22a₁ is different from the Ni content in the other first side portion 22a₂. For example, the Ni content in the one first side portion 22a₁ is greater than the Ni content in the other first side portion 22a₂.

The Ni content in the one second side portion 22b₁ is different from the Ni content in the other second side portion 22b₂. For example, the Ni content in the one second side portion 22b₁ is greater than the Ni content in the other second side portion 22b₂.

In each of the dielectric layers 14 on which a respective one of the first inner electrode layers 16a is provided, when the Ni content in the other first side portion 22a₂ is taken as 1, the Ni content in the one first side portion 22a₁ is about 1.70 or greater, for example.

In each of the dielectric layers 14 on which a respective one of the first inner electrode layers 16a is provided, when the Ni content in the other second side portion 22b₂ is taken as 1, the Ni content in the one second side portion 22b₁ is about 1.70 or greater, for example.

In each of the dielectric layers 14 on which a respective one of the first inner electrode layers 16a is provided, when the brightness value of the other first side portion 22a₂ is taken as 1, the brightness value of the one first side portion 22a₁ is preferably about 0.98 or less, for example.

In each of the dielectric layers 14 on which a respective one of the first inner electrode layers 16a is provided, when the brightness value of the other second side portion 22b₂ is taken as 1, the brightness value of the one second side portion 22b₁ is preferably about 0.98 or less, for example.

Note that, if the Ni content on the side opposite to the side that enters the firing furnace is excessively increased, the dimensional shrinkage rate on the side opposite to the side that enters the firing furnace increases, causing a difference in dimensional shrinkage, and structural defects may sometimes occur.

For this reason, when the Ni content in the other first side portion 22a₂ and the Ni content in the other second side portion 22b₂ are each taken as 1, the Ni content in the one first side portion 22a₁ and the Ni content in the one second side portion 22b₁ are each preferably about 2.65 or less, for example.

In addition, when the brightness value of the other first side portion 22a₂ and the brightness value of the other second side portion 22b₂ are each taken as 1, the brightness value of the one first side portion 22a₁ and the brightness value of the one second side portion 22b₁ are each preferably about 0.86 or greater, for example.

Each of the dielectric layers 14 on which a respective one of the second inner electrode layers 16b is provided includes a third side portion 23a that is located between the fifth surface 12e and the second opposing electrode portion 25b and a fourth side portion 23b that is located between the sixth surface 12f and the second opposing electrode portion 25b.

In each of the dielectric layers 14 on which a respective one of the second inner electrode layers 16b is provided, the third side portion 23a includes one third side portion 23a₁ that is located closer to the third surface 12c and another third side portion 23a₂ that is located closer to the fourth surface 12d, on opposite sides of the position where the corresponding first extended portion 26a is located.

In each of the dielectric layers 14 on which a respective one of the second inner electrode layers 16b is provided, the fourth side portion 23b includes one fourth side portion 23b₁ that is located closer to the third surface 12c and another fourth side portion 23b₂ that is located closer to the fourth surface 12d, on opposite sides of the position where the corresponding second extended portion 26b is located.

The Ni content in the one third side portion 23a₁ may be different from the Ni content in the other third side portion 23a₂. For example, the Ni content in the one third side portion 23a₁ may be greater than the Ni content in the other third side portion 23a₂.

The Ni content in the one fourth side portion 23b₁ may be different from the Ni content in the other fourth side portion 23b₂.

For example, the Ni content in the one fourth side portion 23b₁ may be greater than the Ni content in the other fourth side portion 23b₂.

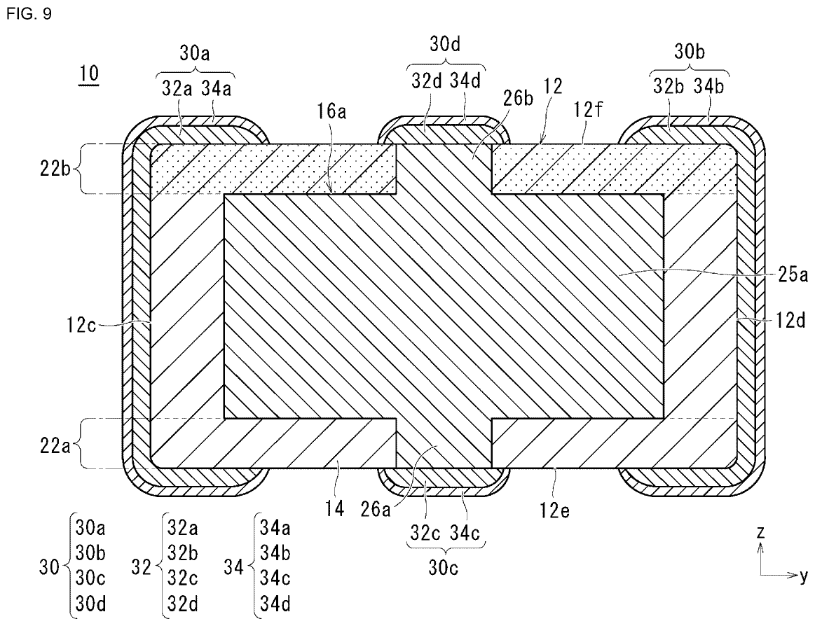

Note that, as illustrated in FIG. 9, in each of the dielectric layers 14 on which a respective one of the first inner electrode layers 16a is provided, the entire first side portion 22a may be a region having a lower Ni content, and the entire second side portion 22b may be a region having a Ni content higher than the Ni content in the entire first side portion 22a.

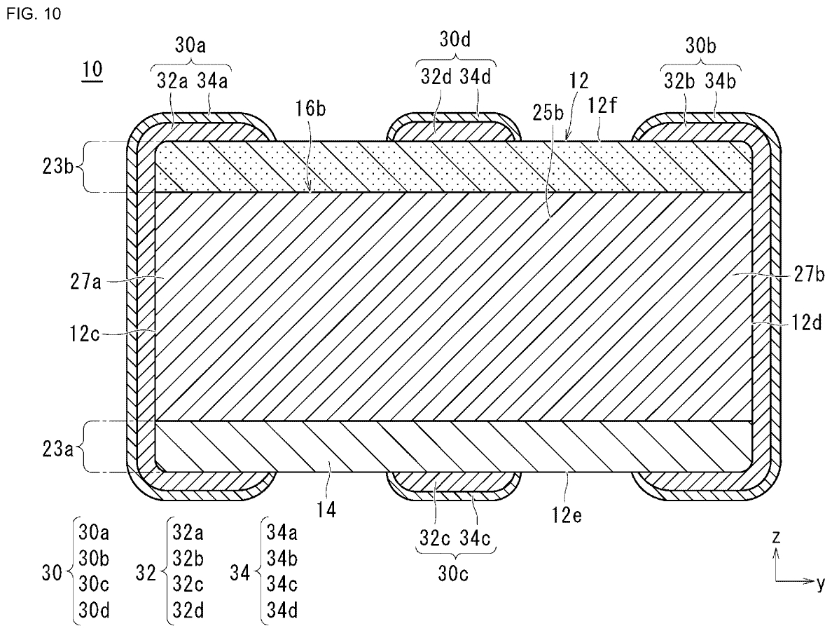

In addition, as illustrated in FIG. 10, in each of the dielectric layers 14 on which a respective one of the second inner electrode layers 16b is provided, the entire third side portion 23a may be a region having a lower Ni content, and the entire fourth side portion 23b may be a region having a Ni content higher than the Ni content in the entire third side portion 23a.

The outer electrodes 30 are disposed on the third surface 12c side and the fourth surface 12d side, and on the fifth surface 12e side and the sixth surface 12f side of the multilayer body 12. The outer electrodes 30 include a first outer electrode 30a, a second outer electrode 30b, a third outer electrode 30c, and a fourth outer electrode 30d.

The first outer electrode 30a is provided on the third surface 12c. In addition, the first outer electrode 30a is connected to the second inner electrode layers 16b. Furthermore, the first outer electrode 30a may also be disposed on a portion of the first surface 12a, a portion of the second surface 12b, a portion of the fifth surface 12e, and a portion of the sixth surface 12f.

The second outer electrode 30b is provided on the fourth surface 12d. In addition, the second outer electrode 30b is connected to the second inner electrode layers 16b. Furthermore, the second outer electrode 30b may also be disposed on a portion of the first surface 12a, a portion of the second surface 12b, a portion of the fifth surface 12e, and a portion of the sixth surface 12f.

The third outer electrode 30c is provided on the fifth surface 12e. In addition, the third outer electrode 30c is connected to the first inner electrode layers 16a. Furthermore, the third outer electrode 30c may include a first covering portion 30c₁ that covers the first inner electrode layers 16a exposed at the fifth surface 12e, a first folded-back portion 30c2 that is formed on the first surface 12a so as to be parallel to the first inner electrode layers 16a, and a second folded-back portion 30c3 that is formed on the second surface 12b so as to be parallel to the first inner electrode layers 16a. By providing the second folded-back portion 30c₃, electrical connection reliability with a mounting substrate 50 can be further maintained.

The fourth outer electrode 30d is provided on the sixth surface 12f. In addition, the fourth outer electrode 30d is connected to the first inner electrode layers 16a. Furthermore, the fourth outer electrode 30d may include a second covering portion 30d₁ (not illustrated) that covers the first inner electrode layers 16a exposed at the sixth surface 12f, a third folded-back portion 30d₂ that is formed on the first surface 12a so as to be parallel to the first inner electrode layers 16a, and a fourth folded-back portion 30d₃ that is formed on the second surface 12b so as to be parallel to the first inner electrode layers 16a. By providing the fourth folded-back portion 30d₃, electrical connection reliability with the mounting substrate 50 can be further maintained.

The outer electrodes 30 include underlying electrode layers 32 that are disposed on the surfaces of the multilayer body 12 and plating layers 34 that are disposed so as to cover the respective underlying electrode layers 32.

The underlying electrode layers 32 include a first underlying electrode layer 32a, a second underlying electrode layer 32b, a third underlying electrode layer 32c, and a fourth underlying electrode layer 32d.

The plating layers 34 include a first plating layer 34a, a second plating layer 34b, a third plating layer 34c, and a fourth plating layer 34d.

In other words, the first outer electrode 30a includes the first underlying electrode layer 32a and the first plating layer 34a. The second outer electrode 30b includes the second underlying electrode layer 32b and the second plating layer 34b. The third outer electrode 30c includes the third underlying electrode layer 32c and the third plating layer 34c. The fourth outer electrode 30d includes the fourth underlying electrode layer 32d and the fourth plating layer 34d.

The first underlying electrode layer 32a is provided on the surface of the third surface 12c of the multilayer body 12 and formed so as to extend from the third surface 12c and to cover a portion of each of the first surface 12a, the second surface 12b, the fifth surface 12e, and the sixth surface 12f.

The second underlying electrode layer 32b is provided on the surface of the fourth surface 12d of the multilayer body 12 and formed so as to extend from the fourth surface 12d and to cover a portion of each of the first surface 12a, the second surface 12b, the fifth surface 12e, and the sixth surface 12f.

Note that the first underlying electrode layer 32a may be disposed only on a surface of the third surface 12c of the multilayer body 12, and the second underlying electrode layer 32b may be disposed only on a surface of the fourth surface 12d of the multilayer body 12.

The third underlying electrode layer 32c is provided on the surface of the fifth surface 12e of the multilayer body 12 and formed so as to extend from the fifth surface 12e and to cover a portion of each of the first surface 12a and the second surface 12b.

The fourth underlying electrode layer 32d is provided on the surface of the sixth surface 12f of the multilayer body 12 and formed so as to extend from the sixth surface 12f and to cover a portion of each of the first surface 12a and the second surface 12b.

The underlying electrode layers 32 include at least one selected from a baked layer, a conductive resin layer, or a thin-film layer, or the like.

The configuration in each of the case where the underlying electrode layers 32 are baked layers, the case where the underlying electrode layers 32 are conductive resin layers, and the case where the underlying electrode layers 32 are thin-film layers will be described below.

The baked layer includes a glass component and a metal component. The glass component of the baked layer includes at least one selected from B, Si, Ba, Mg, Al, or Li, or the like. The metal component of the baked layer includes, for example, at least one selected from Cu, Ni, Ag, Pd, an Ag—Pd alloy, or Au, or the like. The baked layer may include a plurality of baked layers. The baked layer is formed by applying a conductive paste including a glass component and a metal component to the multilayer body 12 and baking the conductive paste. Alternatively, the baked layer may be formed by simultaneously firing a stacked chip including the inner electrode layers 16 and the dielectric layers 14 and a conductive paste applied to the stacked chip, or may be formed by firing a stacked chip including the inner electrode layers 16 and the dielectric layers 14 to obtain the multilayer body 12 and then applying a conductive paste to the multilayer body 12 and baking the conductive paste. Note that in the case where the stacked chip including the inner electrode layers 16 and the dielectric layers 14 and the conductive paste applied to the stacked chip are simultaneously fired, the baked layer is preferably formed by baking a material to which a dielectric material is added instead of the glass component.

Regarding a center portion in the stacking direction x of the first underlying electrode layer 32a located at the third surface 12c, the thickness of the center portion in the first direction y connecting the third surface 12c and the fourth surface 12d is preferably about 10 μm or greater and about 50 μm or less, for example.

In addition, regarding a center portion in the stacking direction x of the second underlying electrode layer 32b located at the fourth surface 12d, the thickness of the center portion in the first direction y connecting the third surface 12c and the fourth surface 12d is preferably about 10 μm or greater and about 50 μm or less, for example.

In a case where the first underlying electrode layer 32a is provided on a portion of the first surface 12a, a portion of the second surface 12b, a portion of the fifth surface 12e, and a portion of the sixth surface 12f, regarding a center portion in the first direction y connecting the third surface 12c and the fourth surface 12d of the first underlying electrode layer 32a located on the first surface 12a and the second surface 12b, the thickness of the center portion in the stacking direction x connecting the first surface 12a and the second surface 12b is preferably, for example, about 5 μm or greater and about 20 μm or less. Furthermore, regarding a center portion in the first direction y connecting the third surface 12c and the fourth surface 12d of the first underlying electrode layer 32a located on the fifth surface 12e and the sixth surface 12f, the thickness of the center portion in the second direction z connecting the fifth surface 12e and the sixth surface 12f is preferably, for example, about 5 μm or greater and about 20 μm or less.

In addition, in the case where the second underlying electrode layer 32b is provided on a portion of the first surface 12a, a portion of the second surface 12b, a portion of the fifth surface 12e, and a portion of the sixth surface 12f, regarding a center portion in the first direction y connecting the third surface 12c and the fourth surface 12d of the second underlying electrode layer 32b located on the first surface 12a and the second surface 12b, the thickness of the center portion in the stacking direction x connecting the first surface 12a and the second surface 12b is preferably, for example, about 5 μm or greater and about 20 μm or less. Furthermore, regarding a center portion in the first direction y connecting the third surface 12c and the fourth surface 12d of the second underlying electrode layer 32b located on the fifth surface 12e and the sixth surface 12f, the thickness of the center portion in the second direction z connecting the fifth surface 12e and the sixth surface 12f is preferably, for example, about 5 μm or greater and about 20 μm or less.

Regarding a center portion in the first direction y connecting the third surface 12c and the fourth surface 12d of the third underlying electrode layer 32c located on the fifth surface 12e, the thickness of the center portion in the second direction z connecting the fifth surface 12e and the sixth surface 12f is preferably about 5 μm or greater and about 20 μm or less, for example.

In addition, regarding a center portion in the first direction y connecting the third surface 12c and the fourth surface 12d of the fourth underlying electrode layer 32d located on the sixth surface 12f, the thickness of the center portion in the second direction z connecting the fifth surface 12e and the sixth surface 12f is preferably about 5 μm or greater and about 20 μm or less, for example.

Regarding a center portion of the third underlying electrode layer 32c, which is located on the first surface 12a, in the first direction y connecting the third surface 12c and the fourth surface 12d, the thickness of the center portion in the stacking direction x connecting the first surface 12a and the second surface 12b is preferably, for example, about 1 μm or greater and about 20 μm or less.

In addition, regarding a center portion of the fourth underlying electrode layer 32d, which is located on the first surface 12a, in the first direction y connecting the third surface 12c and the fourth surface 12d, the thickness of the center portion in the stacking direction x connecting the first surface 12a and the second surface 12b is preferably, for example, about 1 μm or greater and about 20 μm or less.

Regarding a center portion of the third underlying electrode layer 32c, which is located on the second surface 12b, in the first direction y connecting the third surface 12c and the fourth surface 12d, the thickness of the center portion in the stacking direction x connecting the first surface 12a and the second surface 12b is preferably, for example, about 1 μm or greater and about 20 μm or less.

In addition, regarding a center portion of the fourth underlying electrode layer 32d, which is located on the second surface 12b, in the first direction y connecting the third surface 12c and the fourth surface 12d, the thickness of the center portion in the stacking direction x connecting the first surface 12a and the second surface 12b is preferably, for example, about 1 μm or greater and about 20 μm or less.

The conductive resin layer may be disposed on the baked layer so as to cover the baked layer, or may be disposed directly on the multilayer body 12 without providing the baked layer. In addition, the conductive resin layer may completely cover the baked layer or may cover a portion of the baked layer. Furthermore, the conductive resin layer may be formed of a plurality of conductive resin layers.

The conductive resin layer includes a thermosetting resin and a metal. Since the conductive resin layer includes the thermosetting resin, the conductive resin layer is more flexible than, for example, a plating film or a baked layer made of a fired product of a conductive paste. Therefore, even when a physical impact or an impact due to a thermal cycle is applied to the multilayer ceramic capacitor 10, the conductive resin layer functions as a buffer layer, so that the occurrence of cracks in the multilayer ceramic capacitor 10 can be prevented.

As the metal included in the conductive resin layer, Ag, Cu, Ni, Sn, Bi, or an alloy thereof can be used. Alternatively, metal powder having a surface coated with Ag can be used. In the case where metal powder having an Ag-coated surface is used, it is preferable to use Cu, Ni, Sn, Bi, or alloy powder thereof as the metal powder. The reason why Ag conductive metal powder is used as the conductive metal is that Ag has the lowest resistivity among metals and is therefore suitable as an electrode material, and that Ag is a noble metal and therefore does not oxidize and has high weather resistance. Another reason is that it is possible to reduce the cost of a metal used as a base material while maintaining the above-described characteristics of Ag.

Alternatively, as the metal included in the conductive resin layer, Cu or Ni that has undergone anti-oxidation treatment can be used. Note that, as the metal included in the conductive resin layer, metal powder having a surface coated with Sn, Ni, or Cu can also be used. When metal powder having a surface coated with Sn, Ni, or Cu is used, it is preferable to use Ag, Cu, Ni, Sn, Bi, or an alloy powder thereof as the metal powder.

The metal included in the conductive resin layer mainly ensures the conductivity of the conductive resin layer. Specifically, as a result of conductive fillers coming into contact with each other, a conductive path is provided inside the conductive resin layer.

Although metal powder having a spherical shape, a flat shape, or the like can be used as the metal included in the conductive resin layer, it is preferable to use a mixture of spherical metal powder and flat metal powder.

As the resin of the conductive resin layer, for example, any one of various known thermosetting resins such as an epoxy resin, a phenol resin, a urethane resin, a silicone resin, and a polyimide resin can be used. Among them, an epoxy resin, which is favorable in heat resistance, moisture resistance, adhesion, and the like, is one of the most suitable resins.

In addition, the conductive resin layer preferably includes a curing agent in addition to the thermosetting resin. In a case where an epoxy resin is used as a base resin, various known compounds such as phenol-based, amine-based, acid anhydride-based, imidazole-based, active ester-based, and amide-imide-based compounds can be used as the curing agent for the epoxy resin.

The thickness of the thickest portion of the conductive resin layer is preferably, for example, about 5 μm or greater and about 25 μm or less.

In a case where a thin-film layer is provided as each of the underlying electrode layers 32, the thin-film layer is formed by a thin-film forming method such as a sputtering method or a vapor deposition method, and is a layer having a thickness of about 1 μm or less in which metal particles are deposited, for example.

The plating layers 34 are disposed so as to cover the underlying electrode layers 32.

Each of the plating layers 34 includes, for example, at least one selected from Cu, Ni, Sn, Ag, Pd, an Ag—Pd alloy, or Au, or the like.

Each of the plating layers 34 may include a plurality of layers. In this case, each of the plating layers 34 preferably has a two-layer structure of a Ni plating layer and a Sn plating layer. The Ni plating layer is used to prevent the underlying electrode layers 32 from being leached by solder when the multilayer ceramic capacitor 10 is mounted. The Sn plating layer is used to improve the wettability of solder when the multilayer ceramic capacitor 10 is mounted to allow for easy mounting. The thickness of each layer of the plating layers 34 is preferably about 1 μm or greater and about 6 μm or less, for example.

Note that the outer electrodes 30 may be formed of only plating layers without providing the underlying electrode layers 32.

Although not illustrated, a structure in which plating layers are provided without providing the underlying electrode layers 32 will be described below.

In any one or each of the first outer electrode 30a, the second outer electrode 30b, the third outer electrode 30c, and the fourth outer electrode 30d, a plating layer may be formed directly on the surface of the multilayer body 12 without providing the underlying electrode layer 32. In other words, the multilayer ceramic capacitor 10 may have a structure including plating layers that are electrically connected to the first inner electrode layers 16a and the second inner electrode layers 16b. In such a case, the plating layers may be formed after a catalyst has been disposed on the surface of the multilayer body 12 as a pretreatment.

Note that, in a case where the plating layers are formed directly on the multilayer body 12 without providing the underlying electrode layers 32, the amount of reduction in the thickness of the underlying electrode layers 32 can be converted to a reduction in height, that is, a reduction in thickness, or to the thickness of the multilayer body 12, that is, the thickness of the capacitance generating portion 18, so that the degree of freedom in designing thin chips can be improved.

Each of the plating layers preferably includes a lower-layer plating electrode formed at the surface of the multilayer body 12 and an upper-layer plating electrode formed at a surface of the lower-layer plating electrode. The lower-layer plating electrode and the upper-layer plating electrode each preferably include, for example, at least one metal selected from Cu, Ni, Sn, Pb, Au, Ag, Pd, Bi, or Zn, or the like, or an alloy including the metal. Furthermore, the lower-layer plating electrode is preferably formed using Ni, which has solder barrier performance, and the upper-layer plating electrode is preferably formed using Sn or Au, which has good solder wettability.

In addition, for example, in a case where the first inner electrode layers 16a and the second inner electrode layers 16b are formed by using Ni, the lower-layer plating electrodes are preferably formed by using Cu having favorable bondability with Ni. Note that the upper-layer plating electrodes may be formed as necessary, and the first outer electrode 30a, the second outer electrode 30b, the third outer electrode 30c, and the fourth outer electrode 30d may each be formed of only the lower-layer plating electrode. Each of the plating layers may have the upper-layer plating electrode as an outermost layer, or another plating electrode may further be formed on the surface of the upper-layer plating electrode.

Here, in a case where the outer electrodes 30 are formed of only plating layers without providing the underlying electrode layers 32, the thickness of each of the plating layers disposed without providing the underlying electrode layers 32 is preferably about 1 μm or greater and about 15 μm or less, for example.

In addition, the plating layers preferably do not contain glass. The proportion of metal per unit volume of each of the plating layers is preferably about 998 by volume or greater, for example.

The dimension of the multilayer ceramic capacitor 10 in the first direction y is defined as a dimension L. The dimension L is about 0.30 mm or greater and about 0.70 mm or less, for example.

The dimension of the multilayer ceramic capacitor 10 in the stacking direction x is defined as a dimension T. The dimension T is about 0.10 mm or greater and about 0.40 mm or less, for example.

The dimension of the multilayer ceramic capacitor 10 in the second direction z is defined as a dimension W. The dimension W is about 0.10 mm or greater and about 0.40 mm or less, for example.

In general, in a step of firing multilayer chips, the multilayer chips are mounted on a sagger, and firing is performed by passing the sagger through a tunnel firing furnace. However, when the orientations of the multilayer chips on the sagger are random, temperature variations occur in the multilayer chips when they enter the firing furnace, and there is a risk that cracks may occur inside the multilayer chips due to a dimensional shrinkage difference resulting from the temperature variations.

In the multilayer ceramic capacitor 10 illustrated in FIG. 1, the Ni content in the one first side portion 22a₁ is different from the Ni content in the other first side portion 22a₂, and the Ni content in the one second side portion 22b₁ is different from the Ni content in the other second side portion 22b₂, so that sintering tends to proceed more easily and a dimensional shrinkage rate tends to increase on the side having a higher Ni content. Thus, by causing the side having a lower Ni content to enter the firing furnace first, the dimensional shrinkage difference due to temperature variations can be reduced, and structural defects can be reduced or prevented.

In addition, in each of the first inner electrode layers 16a of the multilayer ceramic capacitor 10 illustrated in FIG. 1, when the brightness value of the other first side portion 22a₂ is taken as 1 and the brightness value of the one first side portion 22a₁ is about 0.98 or less, and when the brightness value of the other second side portion 22b₂ is taken as 1 and the brightness value of the one second side portion 22b₁ is about 0.98 or less, for example, the color appearance differs between the one first and second side portions 22a₁, 22b₁ and the other first and second side portions 22a₂, 22b₂, and thus, it becomes possible to align the multilayer chips in a fixed direction, so that the multilayer chips can be aligned such that the side having a lower Ni content enters the firing furnace first.

Next, a non-limiting example of a method for manufacturing the multilayer ceramic capacitor 10 according to an example embodiment of the present invention will be described.

First, a dielectric sheet for a dielectric layer and a conductive paste for an inner electrode layer are prepared. The dielectric sheet and the conductive paste for an inner electrode layer include a binder and a solvent. The binder and the solvent may be known ones.

The conductive paste for an inner electrode layer is printed in a predetermined pattern on the dielectric sheet by, for example, screen printing, gravure printing, or the like. As a result, a dielectric sheet on which a pattern of a first inner electrode layer is formed and a dielectric sheet on which a pattern of a second inner electrode layer is formed are prepared. More specifically, a gravure printing plate for forming the first inner electrode layer and a gravure printing plate for forming the second inner electrode layer are prepared, so that each of the inner electrode layers can be formed.

Next, a pattern of the first inner electrode layer and a pattern of the second inner electrode layer are formed by gravure printing, and then, Ni powder is deposited by, for example, inkjet printing such that the Ni content in one first side portion and the Ni content in another first side portion are different from each other. Similarly, Ni powder is deposited by inkjet printing such that the Ni content in one second side portion and the Ni content in another second side portion are different from each other. In this case, the particle size of the Ni powder that is deposited is preferably about 1/10 or less of the particle size of Ni in the inner electrode layer, for example. As a result, shrinkage can be facilitated.

Next, a predetermined number of dielectric sheets on which no inner electrode layer pattern is printed are stacked, so that a portion that is to be the second outer layer portion 20b on the second surface 12b side is formed. After that, the dielectric sheets on which the first inner electrode layer is printed and the dielectric sheets on which the second inner electrode layer is printed are alternately stacked, so that a portion that is to be the capacitance generating portion 18 is formed. Next, a predetermined number of dielectric sheets on which no inner electrode layer pattern is printed are stacked on the portion that is to be the capacitance generating portion 18, so that a portion that is to be the first outer layer portion 20a on the first surface 12a side is formed. As a result, a stacked sheet is produced.

Subsequently, the stacked sheet is pressed in the stacking direction by means such as an isostatic press, so that a stacked block is produced.

Next, the stacked block is cut into a predetermined size, so that a stacked chip is cut out. In this case, corner portions and ridge portions of the stacked chip may be rounded by barrel polishing or the like.

Then, the stacked chip that has been cut out is fired, thereby producing the multilayer body 12 (step of firing the stacked chip). Although it depends on the materials of the dielectric layers 14 and the inner electrode layers 16, the firing temperature in the step of firing the stacked chip is preferably about 900° C. or higher and about 1400° C. or lower, for example.

The step of firing stacked chips is specifically performed as follows.

In other words, first, stacked chips are fed into a pallet such that LT including surfaces (surfaces the first direction y and the stacking direction x) face a surface. After the stacked chips have been fed into the pallet, a difference in color appearance between a side portion located on the fifth surface side and a side portion located on the sixth surface side of each of the stacked chips is determined by, for example, image analysis using a camera. After that, the stacked chips in the pallet are picked up by a mounter and are aligned in a sagger such that their orientations are aligned based on the color appearance on the fifth surface side or the sixth surface side of each of the stacked chips.

With the structure obtained by the above manufacturing method, since the color appearance differs between the side portion located on the fifth surface side and the side portion located on the sixth surface side, it becomes possible to align the stacked chips in a fixed direction, so that the stacked chips can be aligned such that their sides having a lower Ni content enter the firing furnace first.

Since sintering tends to proceed more easily and a dimensional shrinkage rate tends to increase when the Ni content is higher, a dimensional shrinkage difference due to temperature variations can be reduced, and structural defects can be reduced or prevented.

The third underlying electrode layer 32c of the third outer electrode 30c is formed on the fifth surface 12e of the multilayer body 12 obtained by firing, and the fourth underlying electrode layer 32d of the fourth outer electrode 30d is formed on the sixth surface 12f of the multilayer body 12.

In a case where baked layers are formed as the underlying electrode layers 32, a conductive paste including a glass component and a metal component is applied, and after that, baking treatment is performed, so that the baked layers are formed as the underlying electrode layers 32. The temperature of the baking treatment in this case is preferably about 700° C. or higher and about 900° C. or lower, for example. In the present example embodiment, each of the underlying electrode layers 32 is formed of a baked layer.

Here, as a method for forming a baked layer, various methods can be used. For example, it is possible to use a method in which the orientation of the multilayer body 12 is aligned by using a camera or a magnet such that the fifth surface 12e or the sixth surface 12f faces downward, and after that, a conductive paste is extruded from a slit or a hole and applied while the multilayer body 12 is held by a holding jig. In the case of this method, by increasing the amount of the conductive paste to be extruded, it is possible to form the third underlying electrode layer 32c and the fourth underlying electrode layer 32d not only on the fifth surface 12e and the sixth surface 12f but also on a portion of the first surface 12a and a portion of the second surface 12b.

Next, the first underlying electrode layer 32a of the first outer electrode 30a is formed on the third surface 12c of the multilayer body 12 obtained by firing, and the second underlying electrode layer 32b of the second outer electrode 30b is formed on the fourth surface 12d of the multilayer body 12. In the present example embodiment, the first underlying electrode layer 32a and the second underlying electrode layer 32b are formed by a dipping method so as to extend not only to the third surface 12c and the fourth surface 12d but also to a portion of the first surface 12a, a portion of the second surface 12b, a portion of the fifth surface 12e, and a portion of the sixth surface 12f.

Note that, in the baking treatment, the first underlying electrode layer 32a of the first outer electrode 30a, the second underlying electrode layer 32b of the second outer electrode 30b, the third underlying electrode layer 32c of the third outer electrode 30c, and the fourth underlying electrode layer 32d of the fourth outer electrode 30d may be simultaneously baked, or the first underlying electrode layer 32a of the first outer electrode 30a and the second underlying electrode layer 32b of the second outer electrode 30b may be baked separately from the third underlying electrode layer 32c of the third outer electrode 30c and the fourth underlying electrode layer 32d of the fourth outer electrode 30d.

Note that, when each of the underlying electrode layers 32 is formed of a conductive resin layer, the conductive resin layer can be formed by the following method. Note that the conductive resin layer may be formed on a surface of the baked layer, or the conductive resin layer may be directly formed as a single layer on the multilayer body 12 without forming the baked layer. As a method for forming the conductive resin layer, a conductive resin paste including a thermosetting resin and a metal component is applied to the baked layer or the multilayer body 12, and heat treatment is performed at a temperature of about 250° C. or higher and about 550° C. or lower, for example, to thermally cure the resin, so that the conductive resin layer is formed. The atmosphere during the heat treatment in this case is preferably an N₂ atmosphere. In addition, in order to prevent scattering of the resin and to prevent oxidation of various metal components, an oxygen concentration is preferably maintained at about 100 ppm or less, for example.

Note that, similar to the method for forming each of the underlying electrode layers 32 of a baked layer, as a method for applying the conductive resin paste, for example, a dipping method, a method of extruding and applying the conductive resin paste from a slit, or a roller transfer method can be used for the formation.

In addition, in a case where each of the underlying electrode layers 32 is formed of a thin-film layer, masking or the like is performed, and the underlying electrode layer 32 can be formed in a region where the outer electrodes 30 are desired to be formed by a thin-film forming method such as a sputtering method or a vapor deposition method. Each of the underlying electrode layers 32 formed of a thin-film layer is a layer having a thickness of about 1 μm or less in which metal particles are deposited, for example.

Furthermore, the outer electrodes 30 may be formed of only plating layers without providing the underlying electrode layers 32. In such a case, the outer electrodes 30 can be formed by the following method.

A plating treatment is performed on the third surface 12c and the fourth surface 12d of the multilayer body 12 such that lower-layer plating electrodes are formed on exposed portions of the second inner electrode layers 16b. Similarly, a plating treatment is performed on the fifth surface 12e and the sixth surface 12f of the multilayer body 12 such that lower-layer plating electrodes are formed on exposed portions of the first inner electrode layers 16a. When the plating treatment is performed, either electrolytic plating or electroless plating may be used. However, electroless plating has a disadvantage in that pretreatment using a catalyst or the like is required in order to increase a plating deposition rate, which makes the process complicated. Therefore, it is typically preferable to use electrolytic plating. As a plating method, it is preferable to use barrel plating. In addition, upper-layer plating electrodes to be formed on surfaces of the lower-layer plating electrodes may be formed as necessary.

Finally, the plating layers 34 are formed. Note that the plating layers 34 may be formed on the surfaces of their respective underlying electrode layers 32 or may be directly formed on the multilayer body 12. In the present example embodiment, the plating layers 34 are formed on the surfaces of their respective underlying electrode layers 32. More specifically, a Ni plating layer as a lower-layer plating layer and a Sn plating layer as an upper-layer plating layer are formed on each of the underlying electrode layers 32. When a plating treatment is performed, either electrolytic plating or electroless plating may be used. However, electroless plating has a disadvantage in that pretreatment using a catalyst or the like is required in order to increase a plating deposition rate, which makes the process complicated. Therefore, it is typically preferable to use electrolytic plating.

The multilayer ceramic capacitor 10 according to the present example embodiment may be manufactured in the manner described above.

Next, in order to confirm the effects of the multilayer ceramic capacitors according to example embodiments of the present invention described above, multilayer ceramic capacitors were manufactured as experimental samples.

Multilayer ceramic capacitors that are samples of Comparative Example and Example 1 to Example 5 were fabricated by using the manufacturing method according to the above-described example embodiment.
Structure of multilayer ceramic capacitor: three-terminal (see FIG. 1)
Dimension (L) of multilayer ceramic capacitor: 0.665 mm
Dimension (W) of multilayer ceramic capacitor: 0.370 mm
Dimension (T) of multilayer ceramic capacitor: 0.330 mm
Thickness of dielectric layer located at capacitance generating portion: 0.48 μm
Thickness of inner electrode layer: 0.38 μm
Number of first inner electrode layers: 155
Number of second inner electrode layers: 155
Thickness of first outer layer portion: 22 μm
Thickness of second outer layer portion: 22 μm
Dimension in first direction between capacitance generating portion and each of third and fourth surfaces: 43 μm
Dimension in second direction of each of first to fourth side portions: 39 μm
Structure of outer electrode
First outer electrode and second outer electrode
Underlying electrode layer: baked layer including conductive metal (Cu) and glass component
Plating layer: two-layer structure of Ni plating layer and Sn plating layer.
Third outer electrode and fourth outer electrode
Underlying electrode layer: baked layer including conductive metal (Cu) and glass component
Plating layer: two-layer structure of Ni plating layer and Sn plating layer

In the samples of Examples, in each of the first inner electrode layers, the Ni content in one first side portion was set to be greater than the Ni content in the other first side portion. In addition, the Ni content in one second side portion was set to be greater than the Ni content in the other second side portion.

In the samples of Comparative Example, the Ni content in one first side portion and the Ni content in the other first side portion were set to approximately the same as each other. In addition, the Ni content in one second side portion and the Ni content in the other second side portion were set to approximately the same as each other.

Note that, in the firing, stacked chips were aligned in a fixed direction such that the other first and second side portions having a lower Ni content entered the firing furnace first. The Ni content and the brightness value were measured on the fifth surfaces or the sixth surfaces (the LT surfaces, which are the surfaces including the first direction y and the stacking direction x).

Evaluation methods used were as follows.

Measurement method for Ni content: The Ni content ratio of each of the side portions on the fifth surface or the sixth surface (the LT surface, which is the surface including the first direction y and the stacking direction x) was measured by elemental mapping using wavelength-dispersive X-ray analysis (WDX analysis) with an electron microscope. The Ni content measured here was defined as the Ni content of each side portion.

### Measurement Instrument for Ni Content: Electron Microscope JXA-8500F

Measurement method for brightness value: Using a brightness meter, the intensity of light emitted from the fifth surfaces or the sixth surfaces (the LT surfaces, which are the surfaces including the first direction y and the stacking direction x) was measured. The intensity of light measured here was defined as the intensity of light of each side portion.

Method for detecting internal structural defects: The occurrence rate of horizontal cracks was determined for each sample by ultrasonic inspection (SAT: Scanning Acoustic Tomograph).

Table 1 shows the evaluation results of internal structural defects with respect to changes in the ratio of Ni content and the ratio of brightness value of each of the one first and second side portions when the other first and second side portions are each taken as 1, for each sample of Example 1 to Example 5 and Comparative Example.

TABLE 1

| | Ratio of Ni Content | | Ratio of Brightness Value | | Internal |
|---|---|---|---|---|---|
| | Side Having Lower Ni | Side Having Higher Ni | Side Having Lower Ni | Side Having Higher Ni | Structural |
| | Content in First Side | Content in First Side | Content in First Side | Content in First Side | Defects |
| Item | Portion | Portion | Portion | Portion | (Number) |
| Comparative | 1.00 | 1.00 | 1.00 | 1.00 | 1/10000 |
| Example | | | | | |
| Example 1 | 1.00 | 1.70 | 1.00 | 0.98 | 0/10000 |
| Example 2 | 1.00 | 1.96 | 1.00 | 0.97 | 0/10000 |
| Example 3 | 1.00 | 2.13 | 1.00 | 0.94 | 0/10000 |
| Example 4 | 1.00 | 2.32 | 1.00 | 0.91 | 0/10000 |
| Example 5 | 1.00 | 2.65 | 1.00 | 0.86 | 0/10000 |

In each of the samples of Example 1 to Example 5, since the Ni content in each of the one first and second side portions was different from the Ni content in each of the other first and second side portions, no internal structural defects were observed.

In addition, when the Ni content in each of the one first and second side portions was varied with the Ni content in each of the other first and second side portions taken as 1, no internal structural defects were observed when it was at least about 1.70 or greater, for example.

Furthermore, when the brightness value of each of the one first and second side portions was varied with the brightness value of each of the other first and second side portions taken as 1, no internal structural defects were observed at least when the brightness value was about 0.98 or less, for example.

In contrast, in the samples of Comparative Example, since the Ni content in each of the one first and second side portions and the Ni content in each of the other first and second side portions were approximately the same as each other, samples having internal structural defects were observed.

From the above results, it became clear that, since sintering tends to proceed more easily and a dimensional shrinkage rate tends to increase when the Ni content is higher, a dimensional shrinkage difference due to temperature variations can be reduced, and structural defects can be reduced or prevented.

Furthermore, since the color appearance of the one side portions and that of the other side portions differ from each other, it becomes possible to align multilayer bodies, which are samples, in a fixed direction, so that they can be aligned such that their sides having a lower Ni content enter the firing furnace first.

Note that, although the example embodiments of the present invention have been disclosed in the above description, the present invention is not limited thereto.

In other words, various changes can be made with respect to the mechanism, shape, material, quantity, position, arrangement, and so forth in the above-described example embodiments without departing from the scope of the technical ideas and purposes of the present invention, and these are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of stacked dielectric layers and a plurality of inner electrode layers stacked on the dielectric layers, a first surface and a second surface facing each other in a stacking direction, a third surface and a fourth surface facing each other in a first direction orthogonal to the stacking direction, and a fifth surface and a sixth surface facing each other in a second direction orthogonal to the stacking direction and to the first direction;
a first outer electrode on the third surface;
a second outer electrode on the fourth surface;
a third outer electrode on the fifth surface; and
a fourth outer electrode on the sixth surface; wherein
the plurality of inner electrode layers include a plurality of first inner electrode layers and a plurality of second inner electrode layers;
each of the first inner electrode layers includes:
a first opposing electrode portion facing a respective one of the second inner electrode layers with a respective one of the dielectric layers interposed therebetween;
a first extended portion extending from the first opposing electrode portion and extended to the fifth surface; and
a second extended portion extending from the first opposing electrode portion and extended to the sixth surface;
each of the dielectric layers on which a respective one of the first inner electrode layers is provided includes a first side portion located between the fifth surface and the first opposing electrode portion and including the first extended portion, and a second side portion located between the sixth surface and the first opposing electrode portion and including the second extended portion;
a size of the multilayer ceramic capacitor in the first direction is about 0.30 mm or greater and about 0.70 mm or less;
a size of the multilayer ceramic capacitor in the second direction is about 0.10 mm or greater and about 0.40 mm or less; and
the first and second side portions include, on opposite sides of the first and second extended portions, respectively, a Ni content on one side and a Ni content on another side that are different from each other.

2. The multilayer ceramic capacitor according to claim 1, wherein, in each of the first and second side portions, when a Ni content on a side including a lower Ni content is taken as 1, a Ni content on a side including a higher Ni content is about 1.70 or greater.

3. The multilayer ceramic capacitor according to claim 1, wherein, in each of the first and second side portions, when a brightness value of a side including a lower Ni content is taken as 1, a brightness value of a side including a higher Ni content is about 0.98 or less.

4. The multilayer ceramic capacitor according to claim 1, wherein
each of the second inner electrode layers includes a second opposing electrode portion facing a respective one of the first inner electrode layers with a respective one of the dielectric layers interposed therebetween;
each of the dielectric layers on which a respective one of the second inner electrode layers is provided includes a third side portion located between the fifth surface and the second opposing electrode portion and a fourth side portion located between the sixth surface and the second opposing electrode portion; and
in each of the third and fourth side portions of the second inner electrode layers, a Ni content on one side and a Ni content on another side are different from each other, on opposite sides of positions where the first and second extended portions of a respective one of the first inner electrode layers are located.

5. The multilayer ceramic capacitor according to claim 1, wherein the multilayer ceramic capacitor is a three-terminal multilayer ceramic capacitor.

6. The multilayer ceramic capacitor according to claim 1, further comprising Sn layers between the first and second inner electrode layers.

7. The multilayer ceramic capacitor according to claim 1, wherein each of the first, second, third and fourth outer electrodes includes an underlying electrode layer and a plating layer.

8. The multilayer ceramic capacitor according to claim 7, wherein the underlying electrode includes at least one of a baked layer, a conductive resin layer or a thin film layer.

9. The multilayer ceramic capacitor according to claim 7, wherein the plating layer covers the underlying electrode.

10. The multilayer ceramic capacitor according to claim 7, wherein the plating layer includes a plurality of layer including at least one of Cu, Ni, Sn, Ag, Pd, an Ag—Pd alloy or Au.

11. A multilayer ceramic capacitor comprising:
a multilayer body including a plurality of stacked dielectric layers and a plurality of inner electrode layers stacked on the dielectric layers, a first surface and a second surface facing each other in a stacking direction, a third surface and a fourth surface facing each other in a first direction orthogonal to the stacking direction, and a fifth surface and a sixth surface facing each other in a second direction orthogonal to the stacking direction and to the first direction;
a first outer electrode on the third surface;
a second outer electrode on the fourth surface;
a third outer electrode on the fifth surface; and
a fourth outer electrode on the sixth surface; wherein
the plurality of inner electrode layers include a plurality of first inner electrode layers and a plurality of second inner electrode layers;
each of the first inner electrode layers includes:
a first opposing electrode portion facing a respective one of the second inner electrode layers with a respective one of the dielectric layers interposed therebetween;
a first extended portion extending from the first opposing electrode portion and extended to the fifth surface; and
a second extended portion extending from the first opposing electrode portion and extended to the sixth surface;
each of the dielectric layers on which a respective one of the first inner electrode layers is provided includes a first side portion located between the fifth surface and the first opposing electrode portion and including the first extended portion, and a second side portion located between the sixth surface and the first opposing electrode portion and including the second extended portion;
a size of the multilayer ceramic capacitor in the first direction is about 0.30 mm or greater and about 0.70 mm or less;
a size of the multilayer ceramic capacitor in the second direction is about 0.10 mm or greater and about 0.40 mm or less; and
a Ni content in the first side portion and a Ni content in the second side portion are different from each other.

12. The multilayer ceramic capacitor according to claim 11, wherein, when a Ni content in the first side portion is taken as 1, a Ni content in the second side portion is about 1.70 or greater.

13. The multilayer ceramic capacitor according to claim 12, wherein, when a brightness value of the first side portion is taken as 1, a brightness value of the second side portion is about 0.98 or less.

14. The multilayer ceramic capacitor according to claim 12, wherein
each of the second inner electrode layers includes a second opposing electrode portion facing a respective one of the first inner electrode layers with a respective one of the dielectric layers interposed therebetween;
each of the dielectric layers on which a respective one of the second inner electrode layers is provided includes a third side portion located between the fifth surface and the second opposing electrode portion and a fourth side portion located between the sixth surface and the second opposing electrode portion; and
a Ni content in the third side portion and a Ni content in the fourth side portion are different from each other.

15. The multilayer ceramic capacitor according to claim 12, wherein the multilayer ceramic capacitor is a three-terminal multilayer ceramic capacitor.

16. The multilayer ceramic capacitor according to claim 12, further comprising Sn layers between the first and second inner electrode layers.

17. The multilayer ceramic capacitor according to claim 12, wherein each of the first, second, third and fourth outer electrodes includes an underlying electrode layer and a plating layer.

18. The multilayer ceramic capacitor according to claim 17, wherein the underlying electrode includes at least one of a baked layer, a conductive resin layer or a thin film layer.

19. The multilayer ceramic capacitor according to claim 17, wherein the plating layer covers the underlying electrode.

20. The multilayer ceramic capacitor according to claim 17, wherein the plating layer includes a plurality of layer including at least one of Cu, Ni, Sn, Ag, Pd, an Ag—Pd alloy or Au.
